(19) United States
(12) Patent Application Publication
(10) Pub. No.: US 2020/0248812 A1
(43) Pub. Date: Aug. 6, 2020

(54) WOVEN CLOTH LAYER SUPPORTED LEAF SEAL

(71) Applicant: SDM Siradisi Arge Ve Muhendislik Sanayi Ticaret Anonim Sirketi, Pendik/Istanbu! (TR)

(72) Inventors: Ertugrul Tolga Duran, Pendik/lstanbul (TR); Caner Akcan, Pendik/lstanbul (TR); Mahmut Faruk Aksit, Pendik/lstanbul (TR)

(21) Appl. No.: 16/604,336

(22) PCT Filed: Apr. 11, 2018
(86) PCT No.: PCT/TR2018/050161

§ 371 Date: Oct. 10, 2019

(30) Foreign Application Priority Data
Apr. 11, 2017 (TR) 2017/05399

(51) Int. Cl. F16J 15/3292; F01D 11/00

(52) U.S. Cl. CPC F16J 15/3292; F01D 11/001

(57) ABSTRACT

The invention relates to the construction of a woven cloth layer (3) designed in a way that it will be placed between metal sheets (2) in order to support them in the sealing element (1) which is mounted to provide sealing around the rotating elements like high/speed rotors, blades in the various mechanisms such as gas and steam turbines, aircraft engines

### TECHNICAL FIELD

This invention relates primarily to the sealing element used to provide sealing between high-pressure zones and low-pressure zones around the movement of rotating elements such as high-speed rotors, blades, which are involved in the various mechanisms of the energy sector such as gas and steam turbines, aircraft engines.

The invention is particularly concerned with the construction of a woven cloth layer designed in a way that to be placed between metal sheets in order to support them in the sealing assembly which is mounted to provide sealing around rotating elements at high speed; and the production method of said woven cloth layer.

### PRIOR ART

In the known state of the art, there are sealing assemblies which are mounted in a circular form around the rotating elements in gas and steam turbines in the energy sector, in aircraft engines and in other apparatus involving high speed rotating blades and rotors. These said sealing assemblies provide sealing between high-pressure zones and low-pressure zones that formed around high-speed rotating turbo machine elements.

In the sealing assemblies there are leaf seals formed from very thin metal sheets (plates, shims) arranged side by side at a specific angle of inclination in circular direction. The energy carried by the leakage flow due to the high pressure difference in the sealed area is transferred to these sheets as the energy passes through the leaf seal. Since metal sheets have no energy-damping properties, leaf seals are exposed for excessive and irregular vibration. Therefore, it is difficult to maintain a stable structure when the pressure difference is high. When they operate in an unstable structure or in an unsuitable frequency interval, they are exposed to fatigue in a very short time, lose their structural integrity and start to spill.

Since the sheets are arranged in a circular direction and at a certain angle of inclination around the shaft, even if the leaves are designed to touch each other, a gap is formed between the leaves at the outer diameter. Significant amount of leakage occurs from that gap. At the same time, the leakage escaping from this gap causes an irregular vibration and damages the leaf seal in a short time. In the existing sealing elements, there is no configuration to cover the gaps between metal sheets.

As a result, improvements have been made in the sealing assemblies of high speed rotating elements, therefore new constructions are needed to eliminate the disadvantages mentioned above and to bring new solutions to existing systems.

### Purpose of the Invention

The present invention relates to the sealing element that meets the requirements mentioned above, eliminates all disadvantages and brings some additional advantages.

The main purpose of the invention is to reinforce the sealing elements in high speed rotating elements and to support metal sheets with woven cloth layers, which are produced to be placed properly between sheets, to make them perform more stable.

Another purpose of the invention is to prevent the vibration-induced deformation of sheet metal plates in cases of pressure difference by placing woven cloth layer produced from metal or non-metal fibers between metal sheets.

Unlike the sheets with isotropic material properties, the invention of woven cloth layer construction aims to provide a more stable structure without losing the flexibility of the sealing element in the radial direction.

Another aim of the invention is to provide metal sheets with the ability to absorb excess energy and vibration transferred to them by using woven cloth layers, and thereby to make metal sheets more stable.

By means of the woven cloth layers to be placed between the leaves, the openings which cause significant leakage in the outer diameter of the conventional metal sheets mentioned above will be minimized. The invention also aims to reduce the amount of leakage flow and provide a better sealing performance by forming a porous medium.

During the manufacturing of the invention, woven cloth layers will be pressed from one end with taper rollers. When woven cloth layers are placed between the sheets in a way that the pressed end remains at the inner diameter, the opening formed in the conventional metal sheets will be closed. In this way, it is aimed to minimize the flow leaking from metal sheets and also to contribute to the dampening of the vibration formed in sheets.

In order to realize all the advantages mentioned above and will be understood in detail below, the invention is a sealing element that comprise various sheets; a front plate which prevents the flow to impact the metal sheets directly and irregularly in order to reduce the amount of leakage towards the flow direction between the high pressure zones and the low pressure zones formed in the ambient during the movement of the rotating elements such as the high speed rotors, blades; a back plate providing mechanical support to the metal sheets; metal sheets arranged side-by-side in a row between said front plate and back plate, around rotating elements, and comprise a woven cloth layer made of metal and/or non-metal durable fibers knitted in various forms and patterns to be placed between metal sheets for dampening vibrations and reducing the amount of leakage.

The structural and characteristic features and all advantages of the invention outlined in the drawings below and in the detailed description made by referring these figures will be understood clearly, and therefore the evaluation should be made considering these figures and detailed explanations.

### BRIEF DESCRIPTION OF DRAWINGS

In order to comprehensively understand the structure of the invention and its advantages with additional elements, it is necessary to evaluate it together with the following figures.

FIG. 1; is a three-dimensional view of the sealing element of the invention.

FIG. 2; is a side view of the sealing element of the invention.

FIG. 3; is a front view of the sealing element of the invention.

FIG. 4; is a representation of closing gaps between flat sheets using the woven cloth layer in the sealing element.

FIG. 5; is a representation of the closing gaps between metal sheets with rolled ends using the woven cloth layer in the sealing element.

FIG. 6; is a detail view of metal sheets with rolled ends and the woven cloth layer placed between them.

FIG. 7; is a representation of the process of forming the woven cloth layer by means of a single roller.

FIG. 8; is a representation of the process of forming the woven cloth layer by means of a double roller.

FIG. 9; is an illustration of samples of woven patterns that can be used in production of woven cloth layer.

### REFERENCE NUMBERS

1. Sealing Element

2. Metal Sheet
2.1. Rolled End

3. Woven cloth layer

4. Front Plate

5. Back Plate

6. Support Ring

7. Spacer

8. Rotating Elements

10. Roller

A: Flow Direction

D: Low Pressure Zone

Y: High Pressure Zone

### DETAILED DESCRIPTION OF THE INVENTION

In this detailed description, preferred structures of the invention of sealing element (1) are explained only for a better understanding of the subject matter and without any restrictive effect.

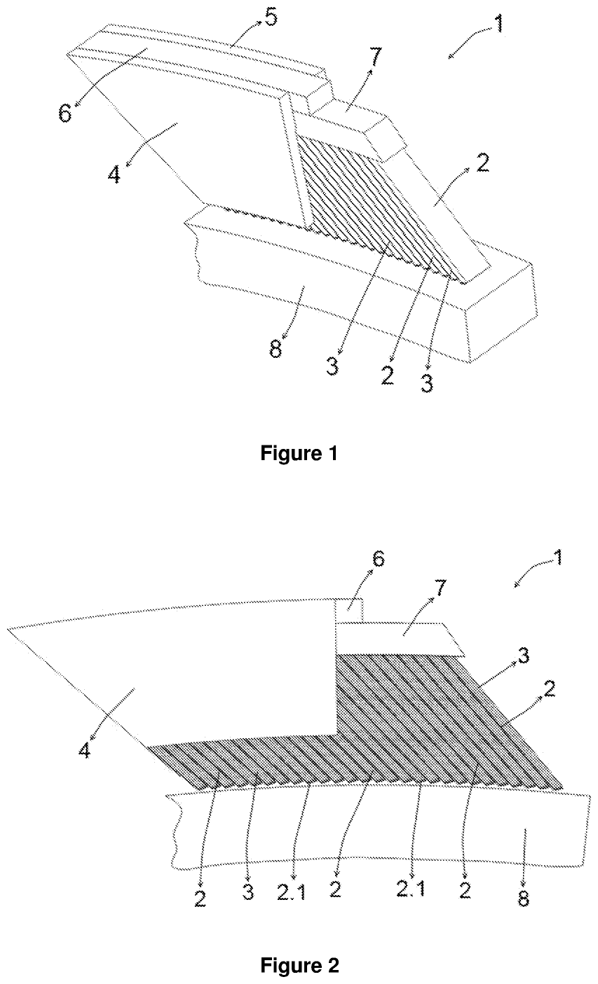

The invention relates primarily to the improvements in the sealing element (1) which is used in order to reduce the amount of leakage flow towards the flow direction (A) between high-pressure zones (Y) and low-pressure zones (D) formed in the ambient during the movement of rotating elements (8) such as high-speed rotors, blades, which are involved in the various mechanisms of the energy sector such as gas and steam turbines, aircraft engines. FIG. 1 shows a three-dimensional view of the related sealing element (1). According to this, sealing element (1) with its overall state, comprises;
a front plate (4) located on the side of high pressure (Y) of the leakage flow, which prevents the flow to impact the metal sheets (2) directly and irregularly,
a back plate (5) located on the low pressure side (D) of the leakage flow, which provides mechanical support to the metal sheets (2) while meeting the explicit force generated on the metal sheets (2) due to pressure difference,
metal sheets (2) arranged side-by-side in a row between front plate (4) and back plate (5), around rotating elements (8) to prevent leakage,
a woven cloth layer (3) made of metal and/or non-metal durable fibers, woven in various forms and patterns to be placed between metal sheets (2) for dampening vibrations in metal sheets (2) during flow and reducing the amount of leakage.

The front plate (4), back plate (5) and metal sheets (2) forming the sealing element (1) are connected by welding or similar binding method.

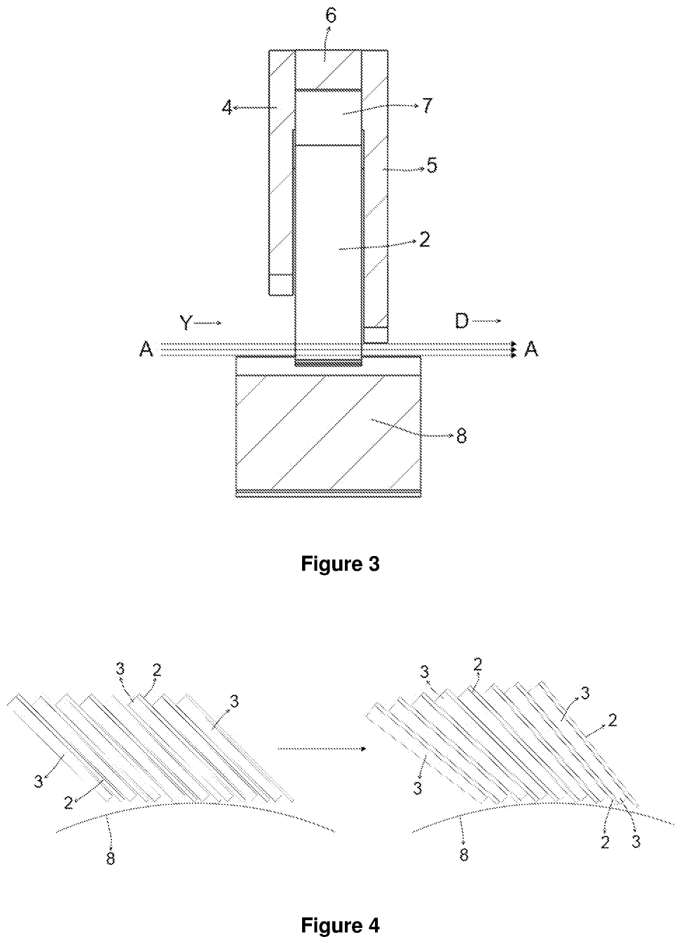

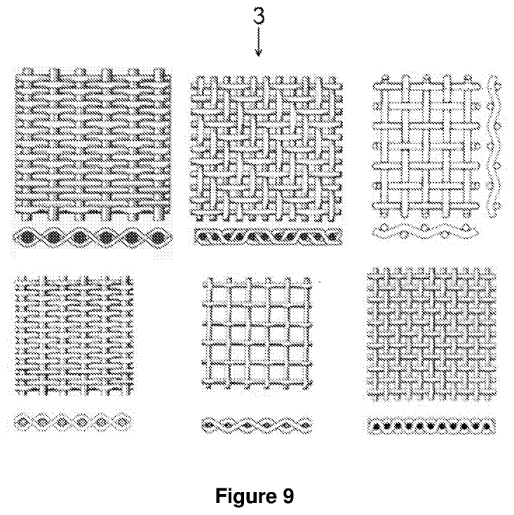

The improvement in the sealing element (1) of the invention is the construction of a woven cloth layer (3) which is placed between metal sheets (2). Said woven cloth layer (3) is a structure which can be woven in various patterns and forms from fibers produced from metal or other durable materials. FIG. 9 shows several examples of woven patterns that can be used in woven cloth layer (3). FIG. 2 shows the side view of the sealing element (1) of the invention. From FIG. 2, the construction of the metal sheets (2) and the woven cloth layer (3) arranged side by side on the rotating element (8) can be seen more clearly. FIG. 3 shows a cross section view of the sealing element (1) from the front profile. In the section in FIG. 3, the leakage direction (A) between the high-pressure zone (Y) and the low-pressure zone (D) can be seen.

The designed woven cloth layers (3) have a flexible structure in the radial direction, unlike metal sheets (2) with isotropic material properties. Through the woven cloth layers (3) placed between metal sheets (2), they are provided with the ability to damper the vibration effects. In this respect, the sealing element (1) will have a more stable structure in the radial direction.

The resistance and sealing performance of sheet metal (2) has been improved by adding woven cloth layers (3) to the sealing elements (1) consisting of metal sheets (2).

For this purpose, woven cloth layers (3),which are formed to cover the gaps opening gradually towards the outer diameter between the metal sheets (2), are designed when the metal sheets (2) are arranged in a concentric form on the surface of the rotating element (8).

The Method of Manufacturing the Woven Cloth Layer in the Sealing Element (1) of the Invention is as Follows:

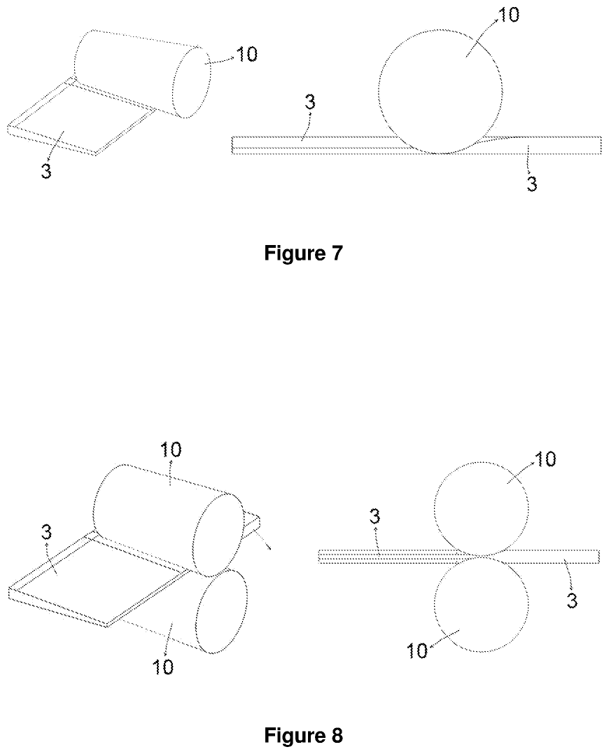

First, woven cloth layers (3) will be pressed from one end with taper roller (10) on a flat surface as shown in FIG. 7, or pressed from both ends with the double roller (10) to form an angular layout as shown in FIG. 8. In the next step, metal sheets (2) in the sealing element (1), in which the design parameters were set according to the operating conditions, are manufactured. The ends of the metal sheets (2) in contact with the rotating element (8) can be manufactured in a straight or curved shape. FIG. 6 shows a detail view of the construction of folded metal sheet (2) and the interlaced woven cloth layer (3). As in FIG. 6, with this structure of metal sheet (2) containing folded end (2.1), the amount of wear on the rotation element (8) is reduced and better aerodynamic lifting force is achieved on metal sheets (2).

After the production of metal sheets (2) and woven cloth layers (3), pairs of metal sheet (2) and woven cloth layer (3) are arranged linearly and are formed to be concentric with the surface of rotating element (8) as shown in FIG. 4. Prepared woven cloth layer (3) and metal sheet (2) pairs are joined to spacer (7) by using methods like welding. The function of the spacer (7) as a part used to adjust the desired gap between sheet metal (2) can be accomplished by woven cloth layer (3). Therefore, the sealing element (1) can also be configured without using the spacer (7). The woven cloth layers (3), metal sheets (2) and spacers (7) that are joined along the linear axis are fixed to each other at both ends after being bent in the desired radius in ring form. Thus, a circular structure is created around the rotation element (8).

The production of the sealing element (1) is completed by combining the woven cloth layers (3), metal sheets (2) and spacers (7), which are arranged in the form of a complete ring, with the back plate (4), the front plate (5) and the support rings (6).

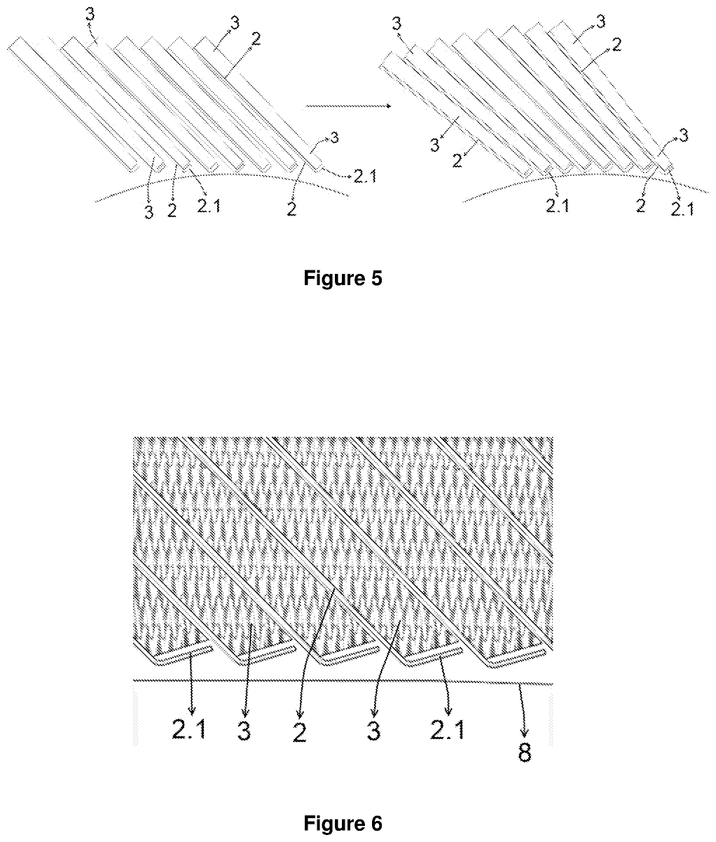

In the sealing element (1), the production of metal sheets (2) by rolling the end that is close to the rotation element (8) with a sheet metal roller machine and/or a similar equipment is also described above. FIG. 5 shows a representation of closing the gaps between the metal sheets (2) with folded ends (2.1) by using woven cloth layer (3).

The vibration-induced deformation of the metal sheets (2) has been reduced to a minimum level in the case of pressure difference due to the construction of the woven cloth layer (3) in the sealing element (1). By the means of woven cloth layer (3), the sealing element (1) has been utilized as a more stable structure without losing its elasticity in radial direction.

1. A sealing element (1) comprising a front plate (4) prevents the flow to impact the metal sheets (2) directly and irregularly, a back plate (5) provides mechanical support to the metal sheets (2), metal sheets (2) arranged side-by-side in a row between front plate (4) and back plate (5) around rotating elements (8) in order to reduce the amount of leakage flow in the flow direction (A) between the high-pressure zone (Y) and the low-pressure zone (D) formed in the ambient during the movement of the rotating elements (8) as high-speed rotating rotor, a flap, characterized in that; it comprises a woven cloth layer (3) made of metal and/or non-metal durable fibers, woven in various forms and patterns to be placed between metal sheets (2) for dampening vibrations in metal sheets (2) during flow and reducing the amount of leakage.

2. A sealing element (1) according to claim 1, characterized in that; it comprises folded ends (2.1) in the portion of the metal sheets (2) contacting the rotating element (8) to reduce wear amount in case of any contact with rotating element (8)

3. The invention is the production method of the woven cloth layer (3) in claim 1, characterized in that; one edge of the woven cloth layer (3) is given form by crushed with a single roller (10) or through double roller (10), in such a way that it can be placed between the metal sheets (2).
